(19) United States
(12) Patent Application Publication
(10) Pub. No.: US 2015/0019796 A1
(43) Pub. Date: Jan. 15, 2015

(54) DATA STORAGE DEVICE AND OPERATING METHOD THEREOF

(71) Applicant: SK hynix Inc., Gyeonggi-do (KR)

(72) Inventor: Eu Joon BYUN, Gyeonggi-do (KR)

(73) Assignee: SK hynix Inc., Gyeonggi-do (KR)

(21) Appl. No.: 14/081,597

(22) Filed: Nov. 15, 2013

(30) Foreign Application Priority Data
Jul. 9, 2013 (KR) 10-2013-0080210

(51) Int. Cl. G06F 12/02

(52) U.S. Cl. CPC G06F 12/0246
USPC 711/103

(57) ABSTRACT

An operating method of a data storage device, which includes a first memory area and a second memory area, includes selecting a victim block for securing a free area from the first memory area, calculating a first cost required when a merge operation for the victim block is performed in the first memory area, calculating a second cost required when the merge operation for the victim block is performed in the second memory area, and performing the merge operation in the first memory area or the second memory area based on the first and second costs.

### CROSS-REFERENCES TO RELATED APPLICATION

The present application claims priority under 35 U.S.C. §119(a) to Korean application number 10-2013-0080210, filed on Jul. 9, 2013, in the Korean Intellectual Property Office, which is incorporated herein by reference in its entirety.

### BACKGROUND

1. Technical Field

Various exemplary embodiments relate to a data storage device, and more particularly, to a data storage device and an operating method thereof, capable of improving an operating speed of the data storage device.

2. Related Art

The recent paradigm for computer surroundings has changed into ubiquitous computing environments in which computer systems may be used anytime and anywhere. Thus, the use of portable electronic devices such as mobile phones, digital cameras, and notebook computers has rapidly increased. Such portable electronic devices generally employ a data storage device using a memory device. The data storage device serves as a main memory device or auxiliary memory device of the portable electronic devices.

Since the data storage device using a memory device has no mechanical driver, the data storage device has excellent stability and durability. Furthermore, the data storage device has high access speed and small power consumption. The data storage device having such advantages includes a universal serial bus (USB) memory device, a memory card having various interfaces, and a solid state drive (SSD).

As the portable electronic devices play a large file such as music file and video file, the data storage device is required to have a large storage capacity. The data storage device includes a plurality of memory devices to increase a storage capacity. In the data storage device including a plurality of memory devices, a high operating speed as well as a large storage capacity is one of important characteristics of the data storage device.

### SUMMARY

Various exemplary embodiments are directed to a data storage device and an operating method thereof, capable of improving the operating speed of the data storage device.

In an exemplary embodiment of the present invention, an operating method of a data storage device, which includes a first memory area and a second memory area, the operating method may include selecting a victim block for securing a free area from the first memory area, calculating a first cost required when a merge operation for the victim block is performed in the first memory area, calculating a second cost required when the merge operation for the victim block is performed in the second memory area, and performing the merge operation in the first memory area or the second memory area based on the first and second costs.

In an exemplary embodiment of the present invention, a data storage device may include a nonvolatile memory device comprising a first memory area and a second memory area, and a controller suitable for selecting a victim block for securing a free area from the first memory area, for calculating a first cost required when a merge operation for the victim block is performed in the first memory area and a second cost required when the merge operation is performed in the second memory area, and for performing the merging operation in the first memory area or the second memory area based on the first and second costs.

### BRIEF DESCRIPTION OF THE DRAWINGS

Features, aspects, and embodiments are described in conjunction with the attached drawings, in which:

FIG. 1 is a flowchart explaining an operating method of a data storage device according to an exemplary embodiment of the present invention;

FIG. 2 is a block diagram illustrating a data processing system including a data storage device according to an exemplary embodiment of the present invention;

FIG. 3 is a diagram explaining a process of performing a merge operation in a first memory area (buffer area) shown in FIG. 2;

FIG. 4 is diagram explaining a process of performing a merge operation in a second memory area (main area) shown in FIG. 2;

FIG. 5 is a block diagram illustrating a data processing system according to an exemplary embodiment of the present invention;

FIG. 6 is a block diagram Illustrating an SSD according to an exemplary embodiment of the present invention;

FIG. 7 is a block diagram illustrating an SSD controller shown in FIG. 6; and

FIG. 8 is a block diagram illustrating a computer system according to an exemplary embodiment of the present invention.

### DETAILED DESCRIPTION

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, reference numerals correspond directly to the like parts in the various figures and embodiments of the present invention.

The drawings are not necessarily to scale and in some instances, proportions may have been exaggerated in order to clearly illustrate features of the embodiments. In this specification, specific terms have been used. The terms are used to describe the present invention, and are not used to qualify the sense or limit the scope of the present invention.

In this specification, ‘and/or’ represents that one or more of components arranged before and after ‘and/or’ is included. Furthermore, ‘connected/coupled’ represents that one component is directly coupled to another component or indirectly coupled through another component. In this specification, a singular form may include a plural form as long as it is not specifically mentioned in a sentence. Furthermore, ‘include/comprise’ or ‘including/comprising’ used in the specification represents that one or more components, steps, operations, and elements exists or are added.

Hereafter, the exemplary embodiments of the present invention will be described with reference to the drawings.

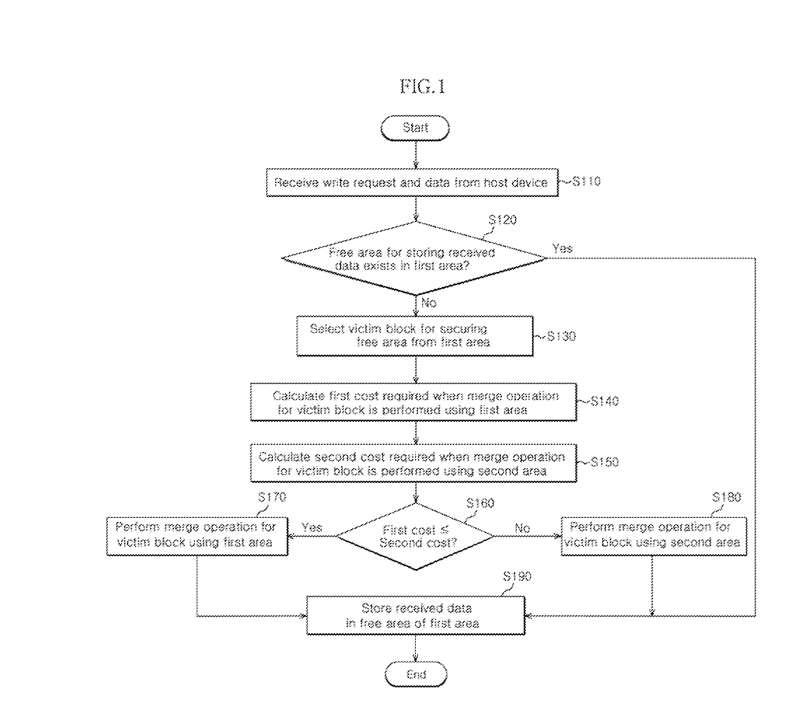

FIG. 1 is a flowchart explaining an operating method of a data storage device according to an exemplary embodiment of the present invention.

The data storage device according to the exemplary embodiment of the present invention may use a buffer program method, in order to secure a high operating speed. For example, the data storage device may program input data to a first memory area (for example, buffer area). Thereafter, the data storage device may program the data programmed in the first memory area to a second memory area (for example, main area) during an idle time.

For example, each of memory cells included in the first memory area may have the number of storable bits less than or a program speed faster than each of memory cells included in the second memory area. Alternatively, each of memory cells included in the first memory area may have the number of storable bits less than and a program speed faster than each of memory cells included in the second memory area. For example, the first memory area may include signal level cells (SLCs) capable of storing one-bit data per cell, and the second memory area may include multi-level cells (MLCs) capable of two or more-bit data per cell.

At step S110, the data storage device receives a write request and data from a host device.

At step S120, the data storage device determines whether is or not a free area for storing the received data exists in the first memory area. The free area may mean an empty storage area or space. In other words, the data storage device determines whether or not the first memory area has the free area enough to store the received data. When the first memory area has the free area enough to store the received data, the procedure proceeds to step S190 and the procedure may be ended. Subsequently, at step S190, the data storage device stores the received data in the free area of the first memory area. On the other hand, when the first memory area does not have the free area enough to store the received data, the procedure proceeds to step S130.

At step S130, the data storage device selects a victim block from the first memory area. That is, the data storage device selects the victim block for securing the free block, and changes the selected victim block into the free block through a merge operation. Through the merge operation of copying valid data stored in the victim block into another area and erasing the victim block, the victim block may be incorporated into the free area.

At step S140, the data storage device calculates a first cost required when the merge operation for the victim block is performed in the first memory area. For example, the first cost is calculated on the basis of a cost required for copying the valid data of the victim block into a free area belonging to the first memory area and a cost required for erasing the victim block.

At step S150, the data storage device calculates a second cost required when the merge operation for the victim block is performed in the second memory area. For example, the second cost is calculated on the basis of a cost required for copying the valid data of the victim block into a free area belonging to the second memory area and a cost required for erasing the victim block.

At step S160, the data storage device determines whether or not the first cost is less than or equal to the second cost. When it is determined that the first cost is less than or equal to the second cost, the procedure proceeds to step S170. At step S170, the data storage device performs the merge operation for the victim block in the first memory area. On the other hand, when the first cost is greater than the second cost, the procedure proceeds to step S180. At step S180, the data storage device performs the merge operation for the victim block in the second memory area.

After the free area for storing the received data is secured through step S170 or S180, the procedure proceeds to step S190. At step S190, the data storage device stores the received data in the free area of the first memory area.

The data storage device may transfer the data stored in the first memory area to the second memory area during a subsequent idle time. That is, the data storage device may store data, which are stored in the first memory area through a buffer programming operation, into the second memory area through a main programming operation.

As described above, the data storage device may secure the free area based on merge costs when the write request is received from the host device. However, when no requests are received from the host device, for example, during an idle time in which no requests are received from the host, the data storage device may secure the free area based on merge costs through steps S120 to S180, in order to prepare for a write request which is to be received in the future.

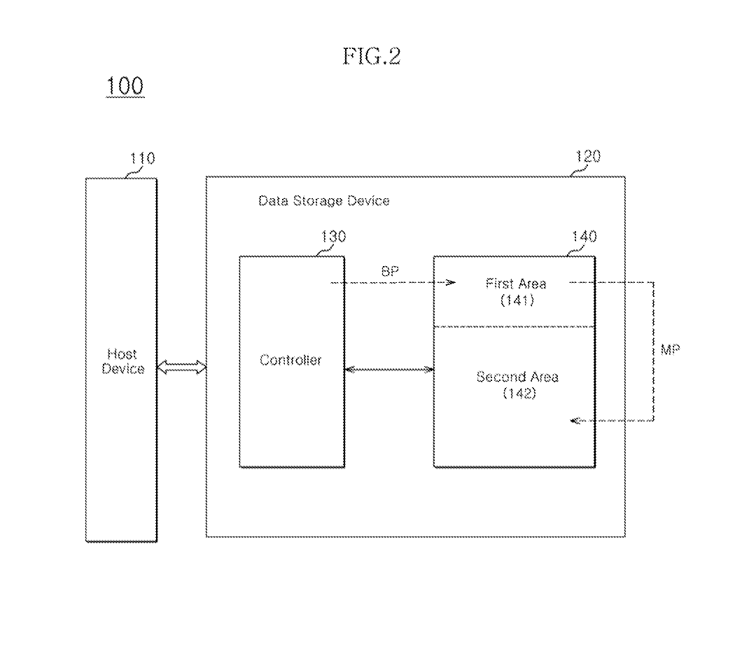

FIG. 2 is a block diagram illustrating a data processing system including a data storage device according to an exemplary embodiment of the present invention.

Referring to FIG. 2, the data processing system 100 may include a host device 110 and a data storage device 120.

The host device 110 may include portable electronic devices such as mobile phones, MP3 players and lap-top computers or electronic devices such as desktop computers, game machines, TVs, and beam projectors.

The data storage device 120 may operate in response to a request from the host device 110. The data storage device 120 may store data accessed by the host device 110. That is, the data storage device 120 may serve as a main memory device or auxiliary memory device of the host device 110.

The data storage device 120 may include a controller 130 and a nonvolatile memory device 140. The controller 130 and the nonvolatile memory device 140 may be implemented with memory devices coupled to the host device 110 through various interfaces. Alternatively, the controller 130 and the nonvolatile memory device 140 may be implemented with a solid state drive (SSD).

The controller 130 may control the nonvolatile memory device 140 in response to the request from the host device 110. For example, the controller 130 may provide data read from the nonvolatile memory device 140 to the host device 110, and may store the data provided from the host device 110 in the nonvolatile memory device 140. For this operation, the controller 130 may control read, program (or write), and erase operations of the nonvolatile memory device 140.

For example, the nonvolatile memory device 140 may be implemented with a flash memory device. The nonvolatile memory device 140 may be divided into a first memory area 141 and a second memory area 142. The first and second memory areas 141 and 142 may be two parts of one memory device. Alternatively, the first and second memory areas 141 and 142 may be different memory devices.

Each of the first and second memory areas 141 and 142 may include a plurality of memory cells. Each of the memory cells may store one-bit data or two or more-bit data. The memory cell capable of storing one-bit data is referred to as a single level cell (SLC). The SLC is programmed to have a threshold voltage corresponding to an erase state and one program state. The memory cell capable of storing two or more-bit data is referred to as a multi-level cell (MLC). The MLC is programmed to have a threshold voltage corresponding to an erase state and any one of a plurality of program states.

The number of bits, which may be stored in each of the memory cells included in the first memory area 141, may be less than the number of bits which may be stored in each of the memory cells included in the second memory area 142. For example, each of the memory cells included in the first memory area 141 may store one-bit data, and each of the memory cells included in the second memory area 142 may store two or more-bit data. For another example, each of the memory cells included in the first memory area 141 may store two-bit data, and each of the memory cells included in the second memory area 142 may store three or more-bit data.

Since the number of bits stored in each of the memory cells included in the first memory area 141 is different from the number of bits stored in each of the memory cells included in the second memory area 142, the first and second memory areas 141 and 142 may be implemented with different types of memory devices. For example, the first memory area 141 may be implemented with an SLC memory device, and the second memory area 142 may be implemented with an MLC memory device. For another example, the first and second memory areas 141 and 142 may be implemented with hybrid memory devices. The hybrid memory device refers to a memory device whose memory cells may be selected and used as any one of an SLC and an MLC. In this case, the memory cells included in the first memory area 141 may be used as the SLC, and the memory cells included in the second memory area 142 may be used as the MLC.

Since the number of bits stored in each of the memory cells included in the first memory area 141 is different from the number of bits stored in each of the memory cells included in the second memory area 142, the memory cells included in the first memory area 141 are accessed in a manner different from the memory cells included in the second memory area 142. For example, it is assumed that each of the memory cells included in the first memory area 141 stores one-bit data and each of the memory cells included in the second memory area 142 stores two-bit data. In this case, the memory cells included in the first memory area 141 may be programmed according to a write method for an SLC, and the memory cells included in the second memory area 142 may be programmed according to a write method for an MLC. Furthermore, data of the memory cells included in the first memory area 141 may be read according to a read method for an SLC, and data of the memory cells included in the second memory area 142 may be read according to a read method for an MLC.

Since the number of bits stored in each of the memory cells included in the first memory area 141 is less than the number of bits stored in each of the memory cells included in the second memory area 142, the memory cells included in the first memory area 141 may have a program speed faster than the memory cells included in the second memory area 142.

Using such characteristics, the controller 130 preferentially programs data provided from the host device 110 to the first memory area 141 in response to a write request from the host device 110. This operation is referred to as a buffer programming (BP) operation. Depending on cases, the first memory area 141 used for the BP operation may be referred to as a buffer area or log area. The controller 130 programs the data temporarily stored in the first memory area 141 to the second memory are 142 after transmitting a response to the write request to the host device 110. For example, during an idle time in which no requests are received from the host device 110, the controller 130 programs the data stored in the first memory area 141 to the second memory area 142. This operation is referred to as a main programming (MP) operation. Depending on cases, the second memory area 142 used for the MP operation may be referred to as a data area.

When the data provided from the host device 110 are programmed through the BP operation and the MP operation, the data storage device 120 may quickly respond to the write request from the host device 110. Thus, the operating speed of the data storage device 120 may be increased. When the first memory area 141 does not have a space enough to perform the BP operation, a space of the first memory area 141 must be secured to perform the BP operation.

That is, as described with reference to FIG. 1, after a merge operation for securing a free area of the first memory area 141 is performed, a BP operation is performed. The first cost required when the merge operation is performed in the first memory area 141 and the second cost required when the merge operation is performed in the second memory area 142 are calculated to secure the free area of the first memory area 141. The first cost and the second cost may change depending on the states of the first and second memory areas 141 and 142. According to the exemplary embodiment of the present invention, when the first cost is less than or equal to the second cost, the merge operation is performed in the first memory area 141 to secure the free area of the first memory area 141. However, when the first cost is greater than the second cost, the merge operation is performed through a free area of the second memory area 142 to secure the free area of the first memory area 141. That is, the data storage device 120 according to the exemplary embodiment of the present invention performs the merge operation so that the cost required for the merge operation for securing the free area of the first memory area 141 may be minimized.

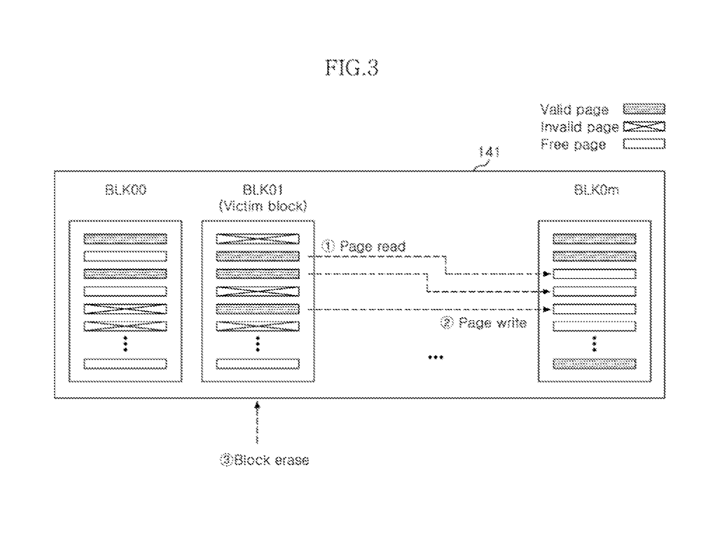

FIG. 3 is a diagram explaining a process of performing a merge operation in the first memory area 141, i.e., the buffer area, shown in FIG. 2.

In FIG. 3, it is assumed that the nonvolatile memory device 140 of FIG. 2 is implemented with the flash memory device. Thus, the nonvolatile memory device 140 performs a read or write operation in units of pages, and performs an erase operation in units of blocks, due to structural characteristics thereof.

FIG. 3 illustrates a process in which valid pages stored in a victim block BLK01 are copied into a target block BLKOm having free pages (\textcircled{1} and \textcircled{2}), and the victim block BLK01 is erased (\textcircled{3}) and changed into a free block, that is, a free area.

When a merge operation for the victim block BLK01 is performed in the first memory area 141, a unit cost required for securing one free page may be defined as Equation 1 below.

Unit cost for securing one free page=(((page read cost of first memory area+page write cost of first memory area)*number of valid pages of victim block)+victim block erase cost)/(number of pages of block in first memory area−number of valid pages of victim block). [Equation 1]

Based on the unit cost for securing one free page, it is possible to calculate the first cost required when the merge operation for securing the free area is performed in the first memory area 141.

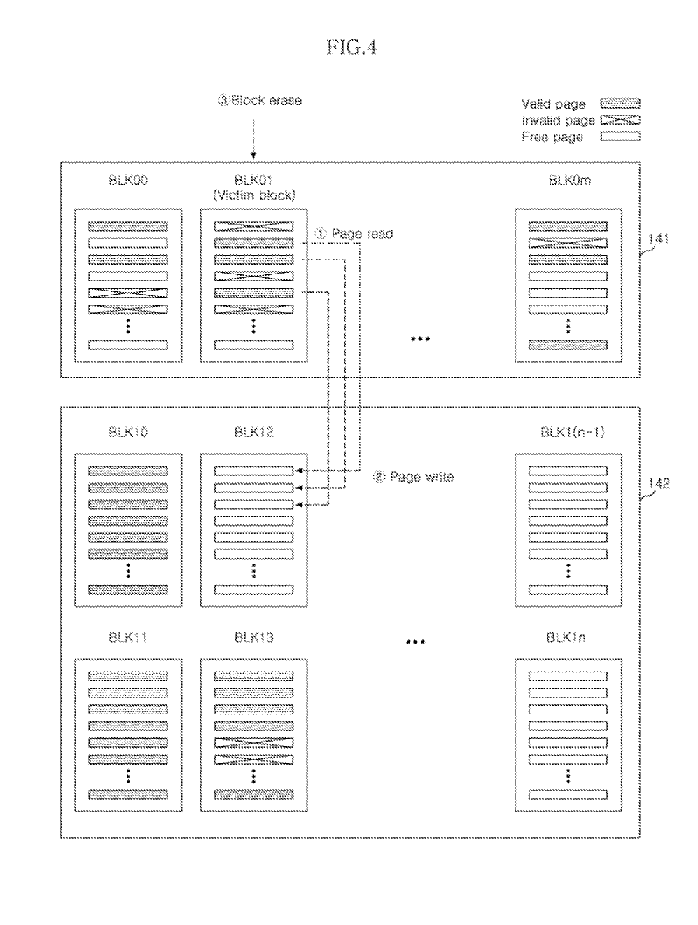

FIG. 4 is diagram explaining a process of performing a merge operation in the second memory area 142, i.e., the main area, shown in FIG. 2.

In FIG. 4, it is assumed that the nonvolatile memory device 140 of FIG. 2 is implemented with the flash memory device 140. Thus, the nonvolatile memory device 140 performs a read or write operation in units of pages, and performs an erase operation in units of the blocks, due to the structural characteristics thereof.

FIG. 4 illustrates a process in which valid pages stored in a victim block BLK01 of the first memory area 141 are copied into a target block BLK12 of the second memory area 142 having free pages (\textcircled{1} and \textcircled{2}), and the victim block BLK01 is erased (\textcircled{3}) and changed into a free block, that is, a free area.

When a merge operation for the victim block BLK01 is performed using the target block BLK12 included in the second memory area 142, a unit cost required for securing one free page may be defined as Equation 2 below.

Unit cost for securing one free page=((((page read cost of first memory area+page write cost of second memory area)*number of valid pages of victim block)+victim block erase cost)/number of pages of block in first memory area)+merge operation cost to be caused by valid pages copied from victim block. [Equation 2]

In Equation 2, ‘the merge operation cost to be caused by the valid pages copied from the victim block’ refers to a cost required for a merge operation that will be performed in the second memory area 142 due to the valid pages copied into the target block BLK12 of the second memory area 142 from the victim block BLK01. Based on the unit cost for securing one free page, it is possible to calculate the second cost required when the merge operation for securing a free area is performed in the second memory area 142.

According to the exemplary embodiment of the present invention, whether to perform the merge operation for securing a free area in the first memory area 141 or the second memory area 142 is selected in response to the cost required when the first or second memory area 141 or 142 is used.

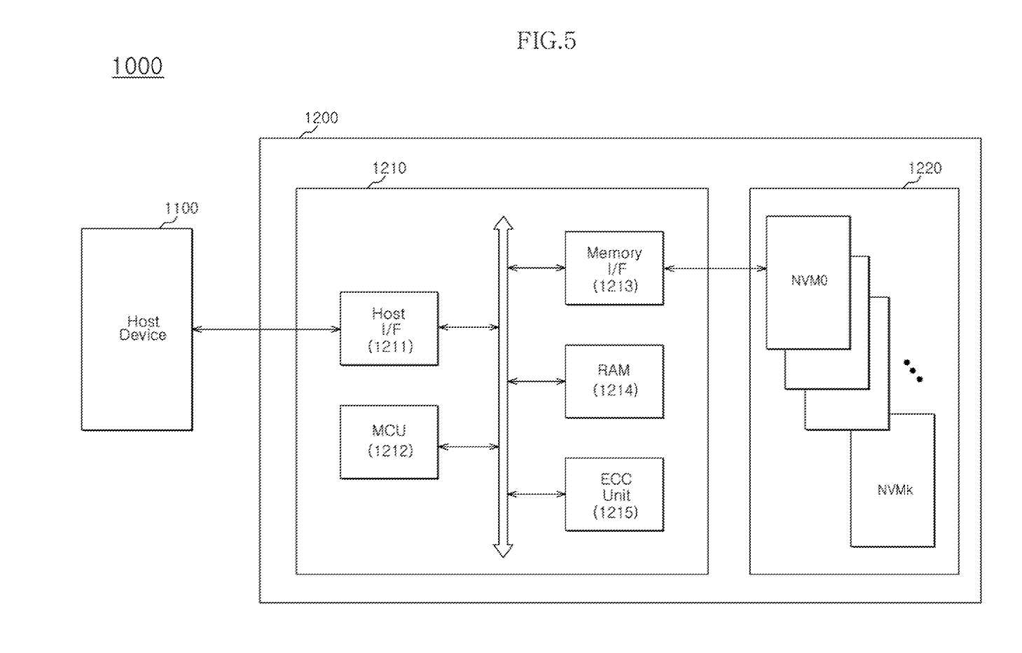

FIG. 5 is a block diagram illustrating a data processing system according to an exemplary embodiment of the present invention.

Referring to FIG. 5, the data processing system 1000 may include a host device 1100 and a data storage device 1200.

The data storage device 1200 may include a controller 1210 and a nonvolatile memory device 1220. The data storage device 1200 may be coupled to the host device 1100 such as a desktop computer, a notebook computer, a digital camera, a mobile phone, an MP3 player, a game machine, or the like. The data storage device 1200 is also referred to as a memory system.

The data storage device 1200 may perform program operations such as the BP operation and the MP operation, and a selective merge operation according to the exemplary embodiment of the present invention. Thus, the performance of the data storage device 1200 may be improved.

The controller 1210 may access the nonvolatile memory device 1220 in response to a request from the host device 1100. For example, the controller 1210 may control a read, program, or erase operation of the nonvolatile memory device 1220. The controller 1210 may execute firmware for controlling the nonvolatile memory device 1220.

The controller 1210 may include a host interface 1211, a micro control unit 1212, a memory interface 1213, a RAM 1214, and an error correction code (ECC) unit 1215.

The micro control unit 1212 may control overall operations of the controller 1210 in response to a request from the host device 1100. The RAM 1214 may serve as a memory of the micro control unit 1212. The RAM 1214 may temporarily store data read from the nonvolatile memory device 1220 or data provided from the host device 1100.

The host interface 1211 may interface the host device 1100 with the controller 1210. For example, the host interface 1211 may communicate with the host device 1100 through one of various Interface protocols such as a Universal Serial Bus (USB) protocol, a Multimedia Card (MMC) protocol, a Peripheral Component Interconnection (PCI) protocol, a PCI-Express (PCI-E) protocol, a Parallel Advanced Technology Attachment (PATA) protocol, a Serial Advanced Technology Attachment (SATA) protocol, a Small Computer System Interface (SCSI) protocol, a Serial Attached SCSI (SAS) protocol and an Integrated Drive Electronics (IDE) protocol.

The memory interface 1213 may interface the controller 1210 with the nonvolatile memory device 1220. The memory interface 1213 may provide a command and address to the nonvolatile memory device 1220. Furthermore, the memory interface 1213 may exchange data with the nonvolatile memory device 1220.

The ECC unit 1215 may detect errors of the data read from the nonvolatile memory device 1220. Furthermore, the ECC unit 1215 may correct the detected errors when the number of detected errors falls within a correction range. The ECC unit 1215 may be is provided inside or outside the controller 1210 depending on the memory system 1000.

The controller 1210 and the nonvolatile memory device 1220 may be integrated into one semiconductor device to form a memory device. For example, the controller 1210 and the nonvolatile memory device 1220 may be integrated into one semiconductor device to form a personal computer memory card international association (PCMCIA) card, a compact flash (CF) card, a smart media card (SMC), a memory stick, a multi-media card (MMC, RS-MMC, or MMC-micro), a secure digital card (SD, Mini-SD, or Micro-SD), or a universal flash storage (UFS) device, or the like.

As another example, the controller 1210 or the nonvolatile memory device 1220 may be mounted as various types of packages. For example, the controller 1210 or the nonvolatile memory device 1220 may be packaged and mounted according to various methods such as a package on package (POP), ball grid arrays (BGAs), chip scale packages (CSPs), a plastic leaded chip carrier (PLCC), a plastic dual in-line package (PDIP), a die in waffle pack, a die in wafer form, a chip on board (COB), a ceramic dual in-line package (CERDIP), a plastic metric quad flat package (MQFP), a thin quad flat package (TQFP), a small outline IC (SOIC), a shrink small outline package (SSOP), a thin small outline package (TSOP), a thin quad flat package (TQFP), a system in package (SIP), a multi-chip package (MCP), a wafer-level fabricated package (WFP), and a wafer-level processed stack package (WSP).

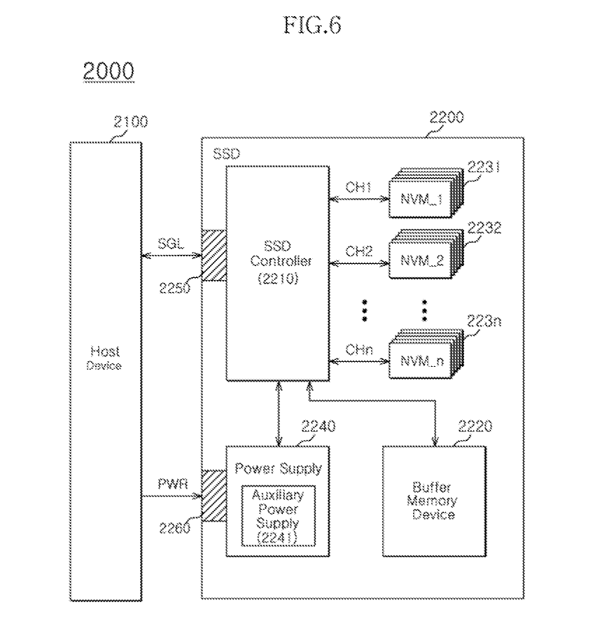

FIG. 6 is a block diagram Illustrating an SSD according to an exemplary embodiment of the present invention.

Referring to FIG. 6, a data processing system 2000 includes a host device 2100 and an SSD 2200.

The SSD 2200 may include an SSD controller 2210, a buffer memory device 2220, a plurality of nonvolatile memory devices 2231 to 223n, a power supply 2240, a signal connector 2250, and a power connector 2260.

The SSD 2200 may operate in response to a request from the host device 2100. That is, the SSD controller 2210 may access the nonvolatile memory devices 2231 to 223n in response to a request from the host device 2100. For example, the SSD controller 2210 may control read, program, and erase operations of the nonvolatile memory devices 2231 to 223n. Furthermore, the SSD controller 2210 may perform program operations such as the BP operation and the MP operation, and a selective merge operation according to the exemplary embodiment of the present invention. Thus, the performance of the SSD 2200 may be improved.

The buffer memory device 2220 may temporarily store data, which are to be stored in the nonvolatile memory devices 2231 to 223n. Furthermore, the buffer memory device 2220 may temporarily store data read from the nonvolatile memory devices 2231 to 223n. The data temporarily stored in the buffer memory device 2220 may be transmitted to the host device 2100 or the nonvolatile memory devices 2231 to 223n, under the control of the SSD controller 2210.

The respective nonvolatile memory devices 2231 to 223n may serve as storage media of the SSD 2200. The respective nonvolatile memory devices 2231 to 223n may be coupled to the SSD controller 2210 through a plurality of channels CH1 to CHn. One channel may be coupled to one or more nonvolatile memory devices. The nonvolatile memory devices coupled to one channel may be coupled to the same signal bus and data bus.

The power supply 2240 may provide power PWR inputted through the power connector 2260 into the SSD 2200. The power supply 2240 includes an auxiliary power supply 2241. The auxiliary power supply 2241 may supply power to normally terminate the SSD 2200 when a sudden power off occurs. The auxiliary power supply 2241 may include super capacitors capable of storing the power PWR.

The SSD controller 2210 may exchange signals SGL with the host device 2100 through the signal connector 2250. The signals SGL may include commands, addresses, data, and the like. The signal connector 2250 may include a connector such as a Parallel Advanced Technology Attachment (PATA), a Serial Advanced Technology Attachment (SATA), a Small Computer System Interface (SCSI), and a Serial Attached SCSI (SAS), according to the interface scheme between the host device 2100 and the SSD 2200.

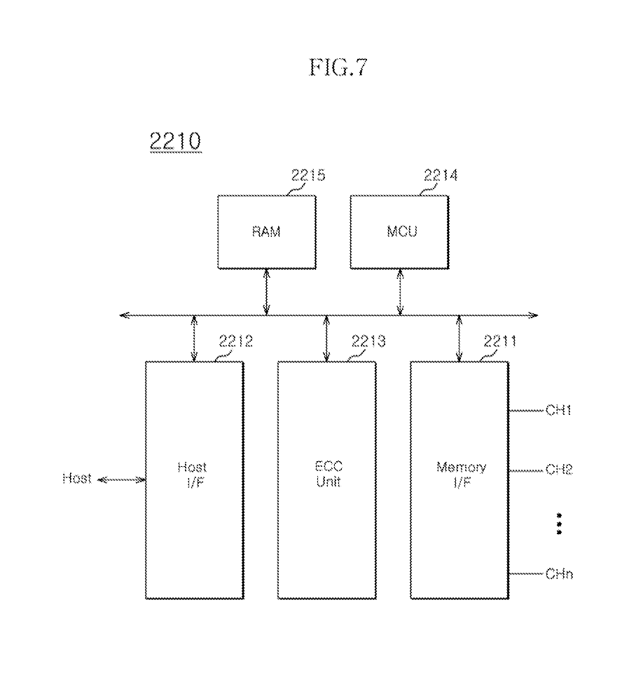

FIG. 7 is a block diagram illustrating the SSD controller shown in FIG. 6.

Referring to FIG. 7, the SSD controller 2210 includes a memory interface 2211, a host interface 2212, an ECC unit 2213, a is micro control unit 2214, and a RAM 2215.

The memory interface 2211 may provide a command and address to the nonvolatile memory devices 2231 to 223n. Furthermore, the memory interface 2211 may exchange data with the nonvolatile memory devices 2231 to 223n. The memory interface 2211 may scatter data transferred from the buffer memory device 2220 over the respective channels CH1 to CHn under the control of the micro control unit 2214. Furthermore, the memory interface 2211 may transfer data read from the nonvolatile memory devices 2231 to 223n to the buffer memory device 2220 under the control of the micro control unit 2214.

The host interface 2212 may interface the SSD 2200 with the host device 2100 in response to the protocol of the host device 2100. For example, the host interface 2212 may communicate with the host device 2100 through any one of a Parallel Advanced Technology Attachment (PATA), a Serial Advanced Technology Attachment (SATA), a Small Computer System Interface (SCSI), a Serial Attached SCSI (SAS) protocols, and the like. Furthermore, the host interface 2212 may perform a disk emulation function of supporting the host device 2100 to recognize the SSD 2200 as a hard disk drive (HDD).

The ECC unit 2213 may generate parity bits based on the data transmitted to the nonvolatile memory devices 2231 to 223n. The generated parity bits may be stored in spare areas of the nonvolatile memory devices 2231 to 223n. The ECC unit 2213 may detect errors of data read from the nonvolatile memory devices 2231 to 223n. When the number of the detected errors falls within a correction range, the ECC unit 2213 may correct the detected errors.

The micro control unit 2214 may analyze and process the signal SGL inputted from the host device 2100. The micro control unit 2214 may control overall operations of the SSD controller 2210 in response to a request from the host device 2100. The micro control unit 2214 may control the operations of the buffer memory device 2220 and the nonvolatile memory devices 2231 to 223n based on firmware for driving the SSD 2200. The RAM 2215 may serve as a memory device for executing the firmware.

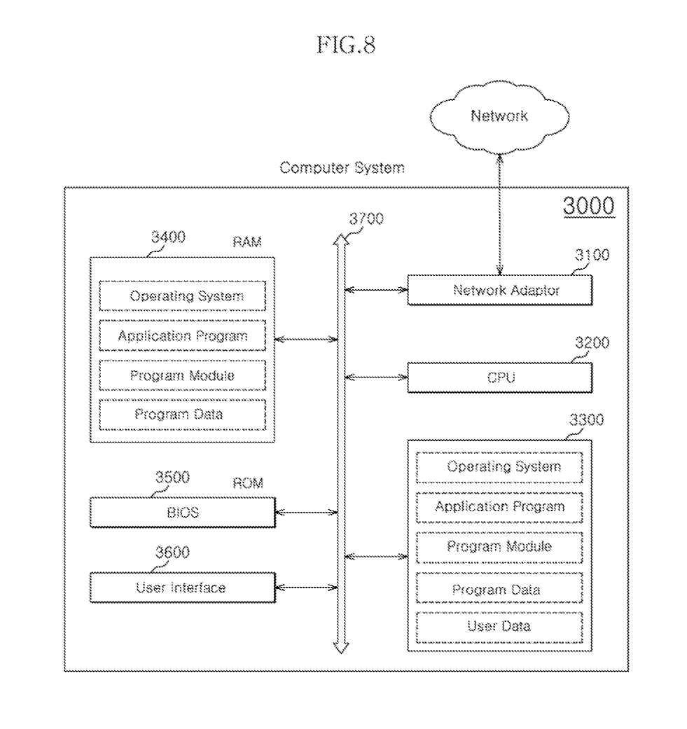

FIG. 8 is a block diagram illustrating a computer system according to an exemplary embodiment of the present invention.

Referring to FIG. 8, the computer system 3000 may include a network adapter 3100, a CPU 3200, a data storage device 3300, a RAM 3400, a ROM 3500, and a user interface 3600, which are electrically coupled to the system bus 3700. The data storage device 3300 may include the data storage device 120 illustrated in FIG. 1, the data storage device 1200 illustrated in FIG. 5, or the SSD 2200 illustrated in FIG. 6.

The network adapter 3100 may provide interfaces between the computer system 3000 and external networks. The CPU 3200 may perform overall arithmetic operations for driving an operating system or application programs residing on the RAM 3400.

The data storage device 3300 may store overall data required by the computer system 3000. For example, the operating system for driving the computer system 3000, application programs, various program modules, program data and user data may be stored in the data storage device 3300.

The RAM 3400 may serve as a memory device of the computer system 3000. During booting, the operating system, application programs and various program modules, which are read from the data storage device 3300, and program data required for driving the programs may be loaded into the RAM 3400. The ROM 3500 may store a basic input/output system (BIOS), which is enabled before the operating system is driven. Through the user interface 3600, information exchange may be performed between the computer system 3000 and a user.

Although not illustrated, the computer system 3000 may further include a battery, application chipsets, a camera image processor (CIP), and the like.

While certain embodiments have been described above, it will be understood to those skilled in the art that the embodiments described are by way of example only. Accordingly, the data storage device described herein should not be limited based on the described embodiments. Rather, the data storage device described herein should only be limited in light of the claims that follow.

What is claimed is:

1. An operating method of a data storage device, which includes a first memory area and a second memory area, the operating method comprising:
selecting a victim block for securing a free area from the first memory area;
calculating a first cost required when a merge operation for the victim block is performed in the first memory area;
calculating a second cost required when the merge operation for the victim block is performed in the second memory area; and
performing the merge operation in the first memory area or the second memory area based on the first and second costs.

2. The operating method according to claim 1, wherein, when the first cost is less than or equal to the second cost, the merge operation for the victim block is performed in the first memory area.

3. The operating method according to claim 2, wherein the performing the merge operation comprises:
copying valid pages of the victim block into free pages of a target block belonging to the first memory area; and
erasing the victim block.

4. The operating method according to claim 1, wherein, when the first cost is greater than the second cost, the merge operation for the victim block is performed in the second memory area.

5. The operating method according to claim 4, wherein the performing the merge operation comprises:
copying valid pages of the victim block into free pages of a target block belonging to the second memory area; and
erasing the victim block.

6. The operating method according to claim 1, further comprising:
storing data stored in the free area of the first memory area, which is secured by the merge operation, into the second memory is area during an idle time of the data storage device.

7. The operating method according to claim 6, wherein the first memory area comprises a buffer area for temporarily storing input data, and the second memory area comprises a data area for storing the input data stored in the first memory area.

8. The operating method according to claim 6, wherein the first memory area and the second memory area are programmed by different write methods.

9. The operating method according to claim 8, wherein each of memory cells included in the first memory area has the number of storable bits less than and/or a program speed faster than each of memory cells included in the second memory area.

10. The operating method according to claim 1, further comprising:
determining whether or not the free area for storing input data exists in the first memory area, wherein the victim block for securing the free area is selected from the first memory area when the free area does not exist in the first memory area.

11. The operating method according to claim 10, further comprising:
storing the input data in the free area of the first memory area, which is secured by the merge operation.

12. A data storage device comprising:
a nonvolatile memory device comprising a first memory area and a second memory area; and
a controller suitable for selecting a victim block for securing a free area from the first memory area, for calculating a first cost required when a merge operation for the victim block is performed in the first memory area and a second cost required when the merge operation is performed in the second memory area, and for performing the merging operation in the first memory area or the second memory area based on the first and second costs.

13. The data storage device according to claim 12, wherein, when the first cost is less than or equal to the second cost, the controller performs the merge operation for the victim block in the first memory area.

14. The data storage device according to claim 13, wherein the controller performs the merge operation by copying valid pages of the victim block into free pages of a target block belonging to the first memory area, and by erasing the victim block.

15. The data storage device according to claim 12, wherein, when the first cost is greater than the second cost, the controller performs the merge operation for the victim block in the second memory area.

16. The data storage device according to claim 15, wherein the controller performs the merge operation by copying valid pages of the victim block into free pages of a target block belonging to the second memory area, and by erasing the victim block.

17. The data storage device according to claim 12, wherein the controller stores data stored in the free area of the first memory area, which is secured by the merge operation, into the second memory area during an idle time.

18. The data storage device according to claim 17, wherein the controller programs the first memory area and the second memory area by different write methods.

19. The data storage device according to claim 18, wherein each of memory cells included in the first memory area has the number of storable bits less than and/or a program speed faster than each of memory cells included in the second memory area.

20. The data storage device according to claim 12, wherein the controller determines whether or not the free area for storing input data exists in the first memory area, and selects the victim block from the first memory area when the free area does not exist in the first memory area.

21. The data storage device according to claim 20, wherein the controller stores the input data in the free area of the first memory area, which is secured by the merge operation.
